(19) United States
(12) Patent Application Publication
(10) Pub. No.: US 2010/0299231 A1
(43) Pub. Date: Nov. 25, 2010

(54) SYSTEM AND METHOD FOR INTELLECTUAL PROPERTY MORTGAGING

(76) Inventor: Isreal Hicks, Arlington, WA (US)

Correspondence Address: BLACK LOWE & GRAHAM, PLLC, 701 FIFTH AVENUE, SUITE 4800, SEATTLE, WA, 98104, US

(21) Appl. No.: 12/790,680

(22) Filed: May 28, 2010

Related U.S. Application Data
(63) Continuation-in-part of application No. 12/203,089, filed on Sep. 2, 2008, now abandoned.
(60) Provisional application No. 60/969,500, filed on Aug. 31, 2007.

(51) Int. Cl. G06Q 99/00; G06Q 40/00

(52) U.S. Cl. 705/30

(57) ABSTRACT

A method that provides industry specific consulting, management, and production services to individual IP producers. More specifically, the method provides intellectual property leveraging strategies, accounting, and finance methods for individual IP producers based on a contractual relationship wherein a business entity delivers the industry specific consulting, management, and production services to the individual IP producer based on the evaluated value of the produced IP product.

### RELATED APPLICATIONS

This application is a continuation in part of U.S. Utility application Ser. No. 12/203,089 filed Sep. 2, 2008, which claims priority to U.S. Provisional Patent Application Ser. No. 60/969,500 filed Aug. 31, 2007. The foregoing applications are incorporated by reference in their entirety as if disclosed herein.

### COPYRIGHT NOTICE

This disclosure is protected under United States and International Copyright Laws. ©2007-2010 Isreal Hicks. All Rights Reserved. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to a business method that provides industry specific consulting, management, and production services to individual IP producers, and more specifically providing intellectual property leveraging strategies for individual IP producers based on a contractual relationship.

### BACKGROUND OF THE INVENTION

The music industry itself is at best stagnant, and at worst, declining as more and more artists/IP producers see managing their own promotion and distribution as a more lucrative way to grow themselves and their art as products than allowing themselves to be “discovered” by a record label and face the risks of losing control of their creative processes. As independent artists/intellectual property (“IP”) producers like Slim Thug and the band Shiny Toy Guns not only sustain themselves, but come to record labels as well-established businesses in their own right, they are able to negotiate better agreements for themselves, or better yet, continue to exist and thrive independent of record label support.

While some artists/IP producers have successfully leveraged their intellectual property to establish a positive revenue stream, this type of business development is often outside the reach of more inexperienced artists/IP producers who are new to the business side of music, lack funds and/or connections. What is needed are intellectual property protection and leveraging services available to small businesses and individuals who wish to manage the production, sale, and distribution/accessibility of their IP products thus leveling the playing field, and giving opportunity for success for all potential entrants regardless of funding or connections.

### SUMMARY OF THE INVENTION

An embodiment of the present invention is a business method for consulting, management, and production wherein a business entity provides intellectual property leveraging strategies, accounting, and finance methods for individual IP producers. The method includes performing an evaluation of an IP product based on the market strength of the IP product produced by the IP producer. The method also includes determining the IP producer's IP needs to produce the IP product. Those needs include at least one of the group of IP development, production, marketing, and/or distribution. The method further includes establishing and documenting a mortgage for the IP producer based on the producer's IP needs and the evaluated IP market strength of the IP product, wherein the business entity takes a financial interest in said IP product. The method additionally includes providing IP needs to the IP producer to produce the IP product, wherein those needs include at least one of the group of IP development, production, marketing, or distribution.

### BRIEF DESCRIPTION OF THE DRAWINGS

Preferred and alternative examples of the present invention are described in detail below with reference to the following drawings:

FIG. 1 is a pie chart to evaluate music sales based on genre of music in one embodiment of the invention;

FIG. 2-1 is an exemplary application the music mortgage provider can utilize in the evaluation process;

FIG. 2-2 is an exemplary tally sheet/evaluation form the music mortgage provider can utilize in its scoring process;

FIG. 3 is a table of the competitive analysis of the music mortgage provider business entity in an exemplary embodiment of the present invention;

FIG. 4 is a block diagram showing a conventional prior-art computer;

FIG. 5 is a screenshot of a calculator used for intellectual property mortgaging according to an embodiment of the invention; and

FIG. 6 shows a method of evaluating intellectual property according to an embodiment of the invention.

### DETAILED DESCRIPTION OF THE PREFERRED EMBODIMENT

An embodiment of the present invention relates to the artistic and/or intellectual property/product development business industry focusing in one embodiment on the music industry. It is to be understood that the music production, recording, and distribution industry is one exemplary embodiment, and that the invention applies to other areas of intellectual property development and distribution.

An embodiment of the present invention relates to a system and method for publishing and music/IP product mortgaging that offers production, distribution, promotion, and intellectual property protection services to small businesses and individual IP producers who wish to manage the sale and accessibility of their IP products. By providing music/IP mortgaging an artist's/IP producer's IP product is leveraged, thus driving innovation by enabling artists/IP producers to bring their creations to the world on their own terms. Moreover, by providing the means to produce and distribute the music/IP product, the music/IP mortgage provider enables new artists/IP producers and innovators to broaden the available audience for their IP products by being a one-stop shop for their service needs and encourages the development of high-quality IP products from talented innovators to raise the bar in their chosen industries, serving as activists for industry change, leveling the playing field and the opportunity for success for all potential entrants regardless of funding or connections.

An embodiment of the present invention supports artists/IP producers willing to take control of their creations and the distribution of those creations to customers/IP consumers. It further raises the bar of innovation by enabling and supporting artists/IP producers who otherwise wouldn't have the opportunity to reach their target audiences.

An embodiment of the present invention relates to the music industry and its talent but can also be used in other industries and their talent, such as software, popular invention, literary and business innovation.

An embodiment of the present invention recognizes that unlike successful independent artists/IP producers such as Slim Thug and Shiny Toy Guns, who had the access to the start-up capital needed to get studio time, print and press CDs (and/or other tangible media), negotiate with and distribute with record shops to carry their IP products, and to market themselves, there are many artists/IP producers with the desire, ability, and drive to be successful, but just need that jumpstart.

An embodiment of the present invention allows artists/IP producers to completely outsource the work that a traditional record company would do on their behalf to a music/IP mortgage provider, based on a contract that is constructed and designed by the artists/IP producers themselves. In one embodiment of the invention, an artist/IP producer can borrow the services needed to promote one song/IP product against the IP rights of that one song/IP product. In contrast a conventional record company agreement often obligates the artist/IP producer to a multi-album deal. An embodiment of the present invention adds the flexibility of time and separation of individual IP products, whether it's a song, a design for a toy, a manuscript, and/or a software prototype, so that the artist/IP producer has more control over what direction their business takes and how it will get there.

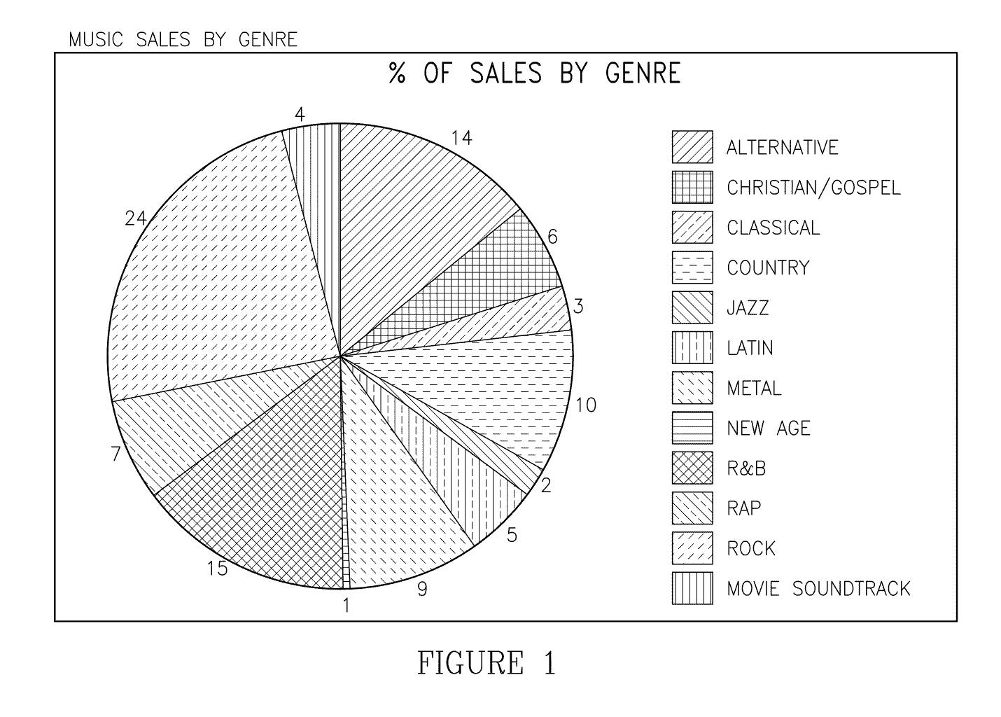

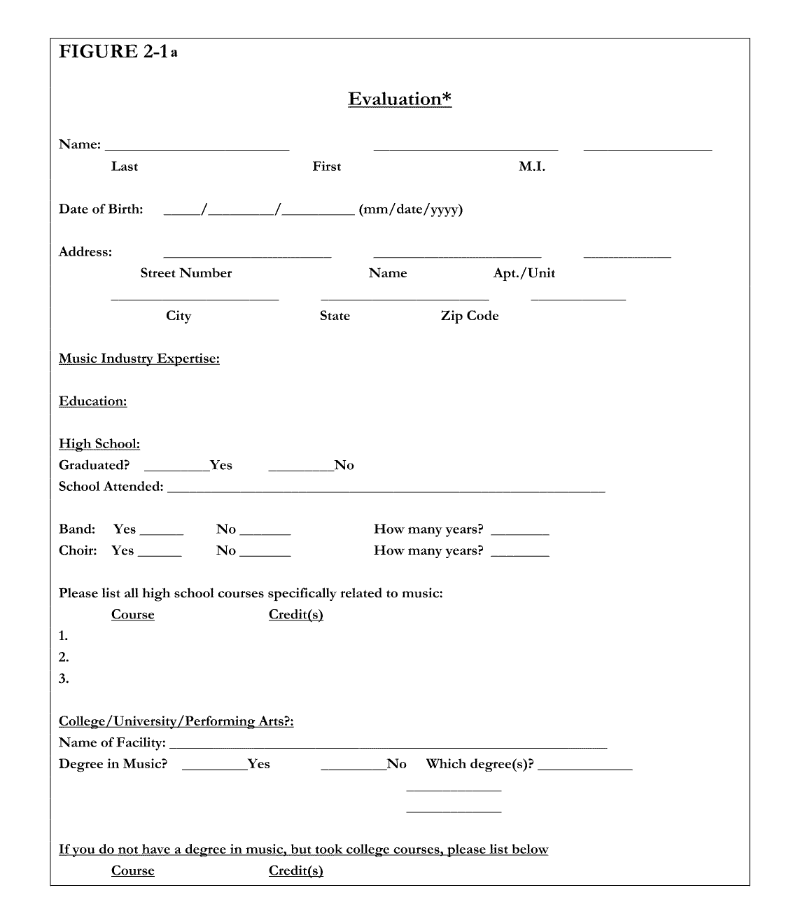

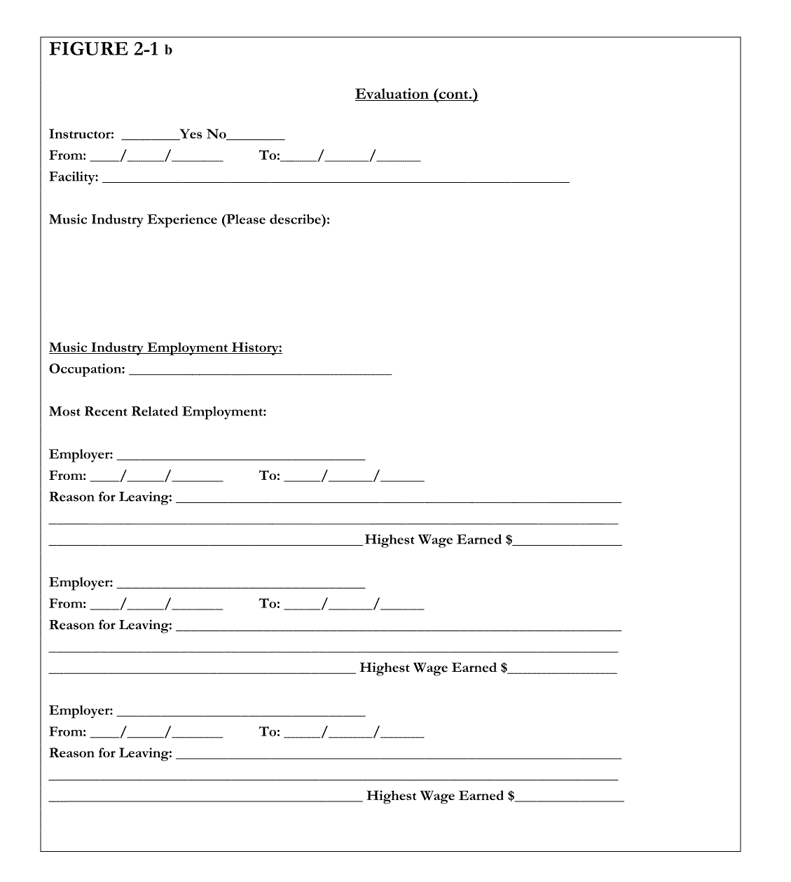

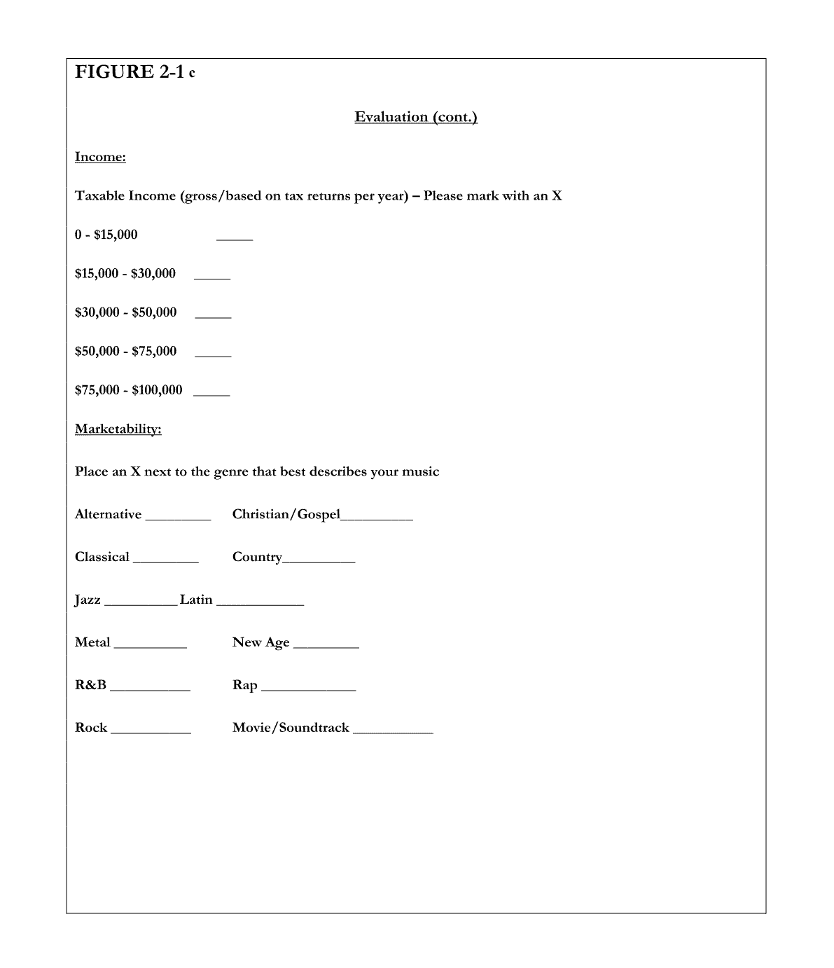

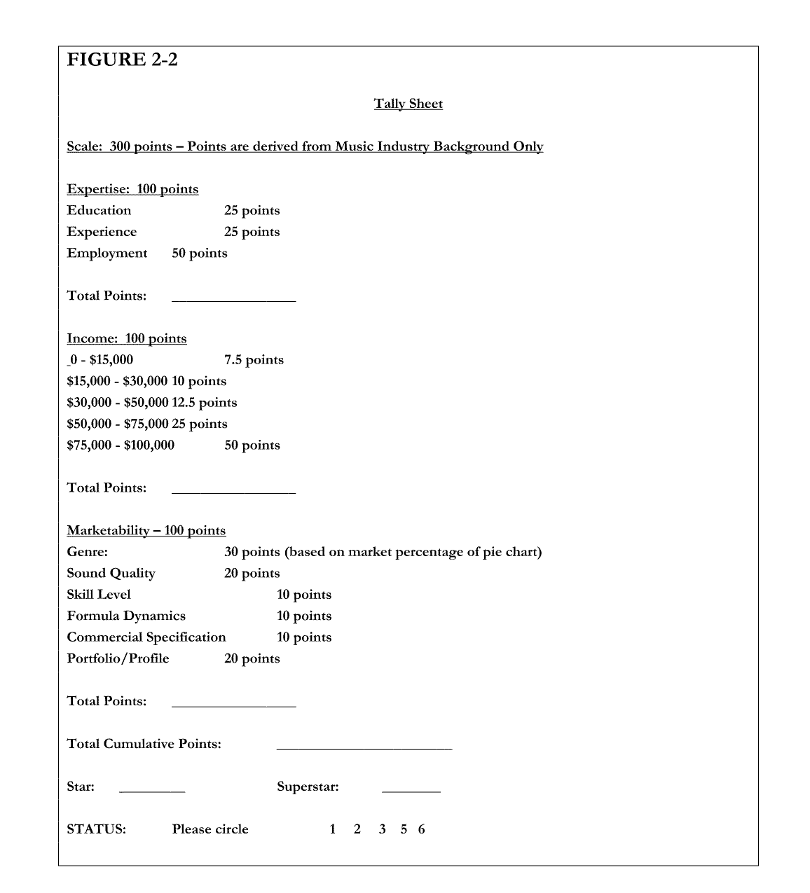

An embodiment of the present invention is a method by which a music mortgage provider evaluates each piece of intellectual property to be valued based on a credit score much like those utilized by banking institutions. Turning to FIG. 1 and FIG. 2-1, in an exemplary embodiment, each individual piece of music/intellectual property has a value that can be assessed based on genre and evaluation of the IP producer. The music mortgage provider places that piece of property in its inventory and/or certifies the purchase value for sale. The music mortgage provider becomes an advocate for both the music mortgage provider as a business entity and the music/IP producer.

Referring now to FIG. 2-2, in this exemplary embodiment, the music mortgage provider's standardized scoring can be based on, although is not limited to the following components:

Scale: 300 points—Points are derived from Music Industry Background Only

Expertise: 100 points

Education: 25 points

Experience: 25 points

Employment: 50 points

Income: 100 points

0-$15,000 7.5 points

$15,000-$30,000 10 points

$30,000-$50,000 12.5 points

$50,000-$75,000 25 points

$75,000-$100,000 50 points

Marketability: 100 points

Genre: 30 points (based on market percentage of pie chart)

Sound Quality: 20 points

Skill Level: 10 points

Formula Dynamics: 10 points

Commercial Specification: 10 points

Portfolio/Profile: 20 points

In the exemplary embodiment, total points awarded to the IP product/producer are then converted into an overall “Status” which, in turn, gives each a dollar value.

1) Mediocre: 0-100 points

Value: $0-$99.00

2) Amateur: 101-200 points

Value: $100.00-$299.00

3) Professional: 201-300 points

Value: $300.00-$499.00

4) Master: 301 and above

Value: $500.00 and above

The music mortgage provider can offer IP producers with intellectual property reaching the Amateur status or above, a potential slot in the music/IP mortgage business entity's inventory.

The music/IP mortgage provider can also utilize two (2) additional “Status” Categories. However, IP producers qualifying in these categories may not need to be scored the same as others due to their established industry credentials. For example,

5) Star: Sold 500,000 CD's or more (Gold)

6) Super Star: Sold 1 million CD's or more (Platinum)

Individual IP producers in these categories can have their intellectual property placed in a catalogue of music to be sold at auction. Terms of the auction will be set by the IP producer. The music mortgage provider in this case can receive a percentage of the auction price of the IP product, for example a commission worth 50% of the auction price.

Products and Services:

For The Independent Artist/Group/IP producer(s) Seeking Mass Marketing:

Mortgage loans secured by intellectual property (IP) product that will be disbursed in the form of services, including, but not limited to the following:

a. Legal advice and available support including contract negotiation and representation;

b. Overall image and portfolio development—serving as an incubation center for new and transitioning artist/IP producer;

c. Publishing management at a flat rate that can be included with the mortgage;

d. Technological distribution and support for the artist's/IP producer's work;

e. Opportunity to gain stable salaries and opportunity for creation via becoming a staff artist/IP producer.

B. For The Independent Artist/Group/IP producer(s) Seeking Staff Work Opportunities:

a. Ability to write, produce, perform, design, and build IP products for a salary in return for the intellectual property rights to all work created;

b. All of the services shown above, should the artist/IP producer choose to pursue the mass market path;

c. Full total compensation packages, providing that the artist/IP producer is accepted.

C. Strengths: An embodiment of the present invention organizes independent distribution and removes the barriers to entry for artists/IP producers, which increases competition and develops additional talent.

a. Customer Demographic: Endless supply of potential customers and suppliers of intellectual property;

b. Connections to Specialists: Non-music/IP mortgage providers such as stylists, video directors, assistants, etc. can be contacted and kept on retainer.

D. Opportunities:

a. Expansion to Other Industries: Representation of other artists/IP producers outside of the music industry, particularly independent software developers, toy and industrial machine designers, and authors.

b. Talent Scout Services: music/IP mortgage provider's work with up and coming artists/IP producers may also enable music/IP mortgage provider to pass artists/IP producers who are looking for record company support to those record companies for a finder's fee.

E. Product and Service Pricing Structures

a. Studio Services for Music Production
i. Audio Services Offered, but are not limited to: Complete Album Production, Mixing/Remixing, Mastering, MIDI Programming, Writing, Arranging, Production and Post-Production, Studio Musicians, Voice Talent, A/V, Film Soundtracks and Scoring, Audio Archiving and Restoration, Advertising Production.
ii. Project-Based Rate System: Overall goals for the recording are discussed at origination, the studio budget is set for time and finances at that point. The budget will be monitored throughout the session to make sure that the artist is not overextended. Budgets are figured at a base rate of, in one example of the embodiment, $500/day, and/or $50/hour. Individual services will be discussed on a case-by-case basis.
iii. Hours of Service: Production days will include studio time, the full service of the facility, production, and engineering.

b. Recording Distribution.
i. Brick and Mortar Retail Distribution: National on-demand distribution to physical stores including, but not limited to: Tower Records®, Circuit City®, Virgin® Megastores, Barnes and Noble®, Guitar Centers®, and smaller independent stores.
ii. Global Online Distribution: Online Distribution will be available through leading online retailers including, but not limited to: Apple iTunes®, Napster®, Rhapsody®, Musicmatch®, Barnes&Noble.com®, TowerRecords.com®, Amazon.com®, and the like.
iii. Sales and Unit Tracking. All recordings submitted to Soundscan, to allow artists/IP producers to prove the number of units moved worldwide.
iv. Online Music Content and Article Sources: Artist and IP product information submitted to Muze®, Loudeye®, and All Music Guide®. online music content providers.
v. Warehousing and Fulfillment: Provided for all orders, allowing artists/IP producers to fulfill all order requests from one location.

c. Artist and Product Development
i. Agent and Legal Representation: Negotiation of live performance contracts, securing and managing bookings to completion, publicist services—a percentage of, for example, 20% of take from bookings, but negotiable on a case-by-case basis.
ii. Career Guidance and Coaching: Career progression mapping, increasing opportunities for creativity, maintaining mental, emotional, and spiritual health for independent artists/IP producers, vocal and dance instruction—for example, $300 per all-inclusive session.
iii. Image Consulting and Photography: In other embodiments of the invention, guidance in visual appearance, verbal and non-verbal communications, interviewing, etiquette, wardrobe consulting, hair styling, and makeover consulting is offered.
iv. Promotion and Publicity: Promotion to national music magazines, music blogs, music podcasts, Internet radio stations, street team support, introductions to industry insiders, press kit assembly and much more.

d. Technological Support
i. Artist Website Support and Maintenance: Website design, building, testing, maintenance, stabilization, and expansion, purchasing and sharing capabilities, and other community and marketing capabilities as needed by the artist.
ii. Digital Intellectual Property Management: Storage and maintenance of digital music, photographs, and other intellectual property is complementary to the artist.

e. Publishing and Royalty Management
i. Income Collection and Management: Supervision of collection and payment of publishing royalties for sales to writers, producers, and performers-complementary to artist.
ii. Intellectual Property Registration: Managing ownership matters and control rights to transcriptions and uses of musical works-complementary to artist.
iii. Use Opportunity Procurement: Securing of opportunities to use intellectual property for other endeavors, such as using a song in a commercial or movie-fee based on income from endeavor.

V. Marketing Plan

Market Research Planning

We can conduct extensive market research to determine demand for our three major profit centers: Royalty loan origination, staff and loan default royalties from publishing, and general music production services.

Primary Data: Interviews with area artists/IP producers, producers, and engineers in the major genres to determine interest in loan origination and creating independent labels.

Secondary Data: Research using archived articles and business information services such as Jupiter Research, Forrester, and other research companies

New and experienced IP producer e.g., singers, songwriters, bands, and producers who are interested in creating independent businesses or gaining steady pay from their art are motivated to build their own labels, and to learn more about the business via their interaction with us.

Record Companies

We are focused on serving record companies who are looking for new talent amongst our ranks (out of those artists/IP producers who are seeking major label deals), those record companies who are looking to outsource the talent scouting and artist/IP producer development functions of their businesses, and record companies who are looking for music to use for their own in-house artists/IP producers.

Record companies can act as both partners and competitors with music/IP mortgage providers. The music/IP mortgage provider can be situated in the market place to compete with traditional record companies for the best artists/IP producers, as well as for the best employees, particularly with those record companies who have full artist support service offerings and who do not choose to outsource those services to the music/IP mortgage provider.

The music/IP mortgage provider's value proposition for independent artists/IP producers is the provision of support and development that a major record label (in the case of the music industry), can provide, not only for a lower cost, but with the expressed intention of helping the independent artist/IP producer retain a larger percentage of their per-sales earnings as an independent business. The music/IP mortgage provider thereby reduces the independent artist's/IP producer's exposure to the music/IP mortgage provider by requiring a percentage of their publishing/IP rights long enough to resolve their obligations to the music/IP mortgage provider, and by not placing obligations on the independent artist/IP producer for the IP rights to their future music recordings/IP product.

Niche Independent Artist Support Companies: Indirect Competition

There are a number of smaller artist support companies that offer one or more of the major components of artist support, such as CD creation and distribution, product and image development, studio time and equipment, management and agent support.

These companies will act as both music/IP mortgage provider partners for outsourcing deals, but also as competitors in that artists/IP producers can deal directly with alternative partners for their services if they wish to do so.

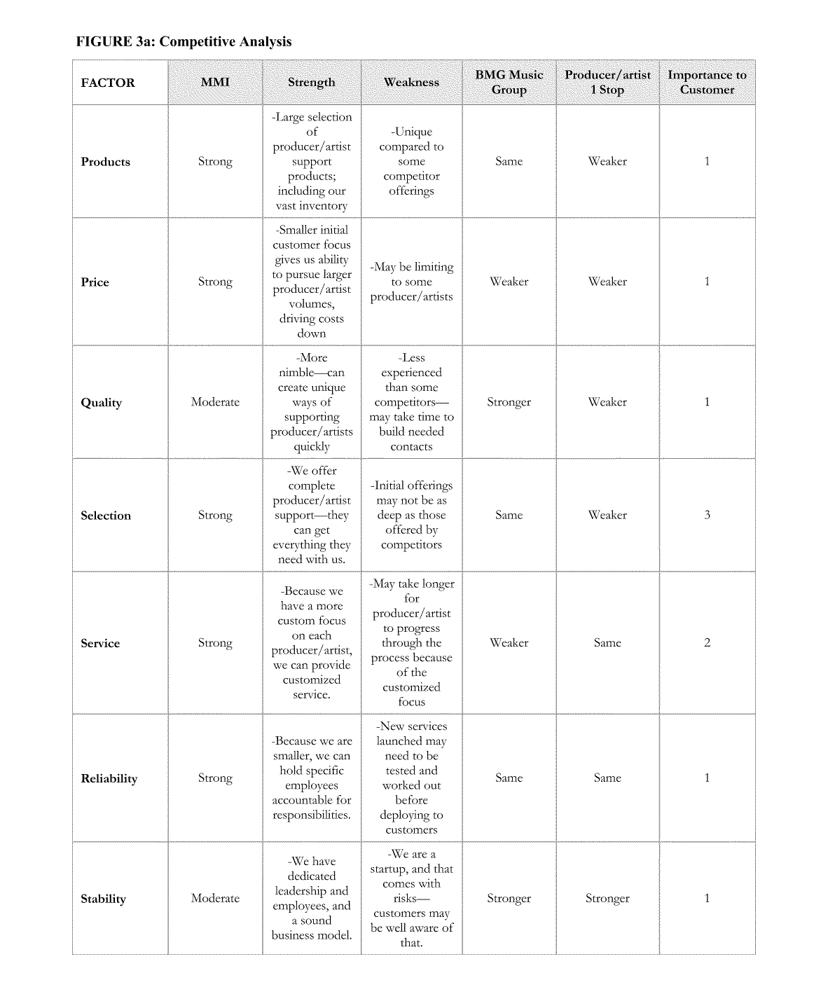

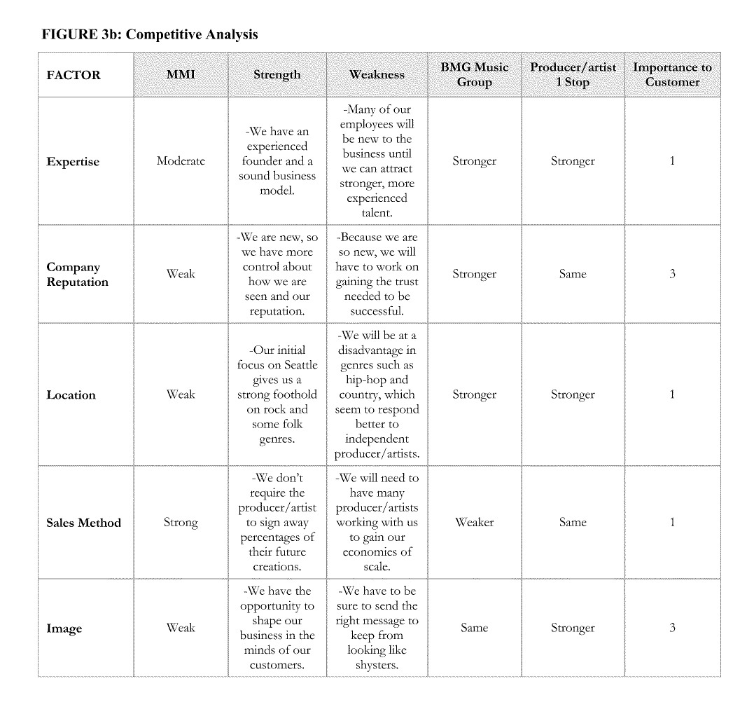

Referring now to FIG. 3 as shown in table, the music mortgage provider's value proposition in response to the above competition is that an artist/IP producer can find all aspects of support in one place, with one agreement, with the music mortgage provider, for a lower price than the artist/IP producer would pay using any number of the niche competitors in this market.

Niche. An embodiment of the present invention is dedicated to providing services to the artist/IP producer so that they have more control, more direction, and more share in the success of their IP products. By doing this, the music/IP mortgage provider can provide the artists/IP producers the financial freedom to define success in their own terms, based on what they, the artist/IP producer, are willing to invest in their IP product, their careers, and their businesses. Direct Marketing: Street Teams And Shameless Self-Promotion

Handing out cards at concerts, club nights, and other places and speaking to artists/IP producers and record company officials about the music mortgage provider's offerings can be one of the most effective and cost-conscious ways for the music mortgage provider to generate interest in the business methods and our services offered by the music mortgage provider. Strengths: This allows the music/IP mortgage provider to learn directly about what IP producers are expecting from the music/IP mortgage provider, and to bring that feedback directly back to inform the practices of music/IP mortgage provider business method. It also provides the artists/IP producers a real-time understanding about what services and benefits the music/IP mortgage provider provides to the IP producer.

Word of Mouth. Advertising can be from artists/IP producers who have had success with the provider and by recommending the music/IP mortgage provider to other artists/IP producers.

Trade Publication Advertising. One means of generating interest and knowledge about the music/IP mortgage provider's services can focus on local advertising in smaller newspapers and magazines that are well-read and quoted in the communities in which the music/IP mortgage provider are active. For instance, rather than publishing in national music magazines such as Guitar Monthly, a local Seattle based music/IP mortgage provider can opt to publish in a targeted local magazine, such as the Stranger, a well known tabloid in Seattle, Wash.

Customer Relationship Management. An embodiment of the present invention includes a database of all customers, their preferences, their purchases, and any feedback they have given regarding improvement of the business. The music/IP mortgage provider can periodically contact IP producers/previous customers with information regarding additional services that the music/IP mortgage provider has determined by the survey to be of interest to the IP producer.

Pricing. An embodiment of the present invention reduces costs to the IP producer by reducing the prices of services, as the music/IP mortgage provider's intended customers are likely to make decisions based heavily on price. The music/IP mortgage provider's business menu of pricing will allow the artist/IP producer a choice in how and when they will use the support the music mortgage provider offers—there is not the necessity to take an entire package of services all at the same time. This allows artists/IP producers to develop their businesses and their careers at their own pace.

Customer service and support will be part of every item that is offered.

In one preferred embodiment the music/IP mortgage provider provides its business method from a web-based site via e-commerce, for example, at one of three exemplary websites: MusicMortgage.com, MusicMortgage.org, or GenreCity.com. It is to be understood, that in later stages of the music/IP mortgage business method development and as the customer partnership develops, the music/IP mortgage provider can have a network of partners, preferably nearest the physical location of IP producers/customers, that will be able to fulfill IP producers/customer needs such as studio work and image consulting wherever the IP producer/customer is located. This will put emphasis on the music/IP mortgage producer's promotional structure.

VI. Operational Plan

Production. The music/IP mortgage provider's products and services are provided at the point of the IP producer's/customer's interaction with the music/IP mortgage provider and/or partners, and are produced by the methods the music/IP mortgage provider and/or partners use to create the IP products. Methods of production, distribution, etc., must meet the music/IP mortgage provider's standards and are of utmost quality for the IP producer/customer.

Legal Environment

Can include:
Licensing and bonding requirements
Permits
Health, workplace, or environmental regulations
Special regulations covering your industry or profession
Zoning or building code requirements
Insurance coverage
Trademarks, copyrights, or patents (pending, existing, or purchased).

FIG. 4 is a block diagram showing a conventional prior-art computer, various computer peripherals, and various communication means for the computer according to an embodiment of the invention. For purposes of brevity and clarity, embodiments of the invention may be described in the general context of computer-executable instructions, such as program application modules, objects, applications, models, or macros being executed by a computer, which may include but is not limited to personal computer systems, hand-held devices, multiprocessor systems, microprocessor-based or programmable consumer electronics, network PCs, mini computers, mainframe computers, and other equivalent computing and processing sub-systems and systems. Aspects of the invention may be practiced in distributed computing environments where tasks or modules are performed by remote processing devices linked through a communications network. Various program modules, data stores, repositories, models, federators, objects, and their equivalents may be located in both local and remote memory storage devices.

By way of example, a conventional personal computer, referred to herein as a computer 100, includes a processing unit 102, a system memory 104, and a system bus 106 that couples various system components including the system memory to the processing unit. The computer 100 will at times be referred to in the singular herein, but this is not intended to limit the application of the invention to a single computer since, in typical embodiments, there will be more than one computer or other device involved. The processing unit 102 may be any logic processing unit, such as one or more central processing units (CPUs), digital signal processors (DSPs), application-specific integrated circuits (ASICs), etc. Unless described otherwise, the construction and operation of the various blocks shown in FIG. 2 are of conventional design. As a result, such blocks need not be described in further detail herein, as they will be understood by those skilled in the relevant art.

The system bus 106 can employ any known bus structures or architectures, including a memory bus with memory controller, a peripheral bus, and a local bus. The system memory 104 includes read-only memory (“ROM”) 108 and random access memory (“RAM”) 110. A basic input/output system (“BIOS”) 112, which can form part of the ROM 108, contains basic routines that help transfer information between elements within the computer 100, such as during start-up.

The computer 100 also includes a hard disk drive 114 for reading from and writing to a hard disk 116, and an optical disk drive 118 and a magnetic disk drive 120 for reading from and writing to removable optical disks 122 and magnetic disks 124, respectively. The optical disk 122 can be a CD-ROM, while the magnetic disk 124 can be a magnetic floppy disk or diskette. The hard disk drive 114, optical disk drive 118, and magnetic disk drive 120 communicate with the processing unit 102 via the bus 106. The hard disk drive 114, optical disk drive 118, and magnetic disk drive 120 may include interfaces or controllers (not shown) coupled between such drives and the bus 106, as is known by those skilled in the relevant art. The drives 114, 118, 120, and their associated computer-readable media, provide nonvolatile storage of computer readable instructions, data structures, program modules, and other data for the computer 100. Although the depicted computer 100 employs hard disk 116, optical disk 122, and magnetic disk 124, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 104, such as an operating system 126, one or more application programs 128, other programs or modules 130 and program data 132. The system memory 104 also includes a browser 134 for permitting the computer 100 to access and exchange data with sources such as web sites of the Internet, corporate intranets, or other networks as described below, as well as other server applications on server computers such as those further discussed below. The browser 134 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. Although the depicted embodiment shows the computer 100 as a personal computer, in other embodiments, the computer is some other computer-related device such as a personal data assistant (PDA), a cell phone, or other mobile device.

The operating system 126 may be stored in the system memory 104, as shown, while application programs 128, other programs/modules 130, program data 132, and browser 134 can be stored on the hard disk 116 of the hard disk drive 114, the optical disk 122 of the optical disk drive 118, and/or the magnetic disk 124 of the magnetic disk drive 120. A user can enter commands and information into the computer 100 through input devices such as a keyboard 136 and a pointing device such as a mouse 138. Other input devices can include a microphone, joystick, game pad, scanner, etc. These and other input devices are connected to the processing unit 102 through an interface 140 such as a serial port interface that couples to the bus 106, although other interfaces such as a parallel port, a game port, a wireless interface, or a universal serial bus (“USB”) can be used. A monitor 142 or other display device is coupled to the bus 106 via a video interface 144, such as a video adapter. The computer 100 can include other output devices, such as speakers, printers, etc.

The computer 100 can operate in a networked environment using logical connections to one or more remote computers, such as a server computer 146. The server computer 146 can be another personal computer, a server, another type of computer, or a collection of more than one computer communicatively linked together and typically includes many or all the elements described above for the computer 100. The server computer 146 is logically connected to one or more of the computers 100 under any known method of permitting computers to communicate, such as through a local area network (“LAN”) 148, or a wide area network (“WAN”) or the Internet 150. Such networking environments are well known in wired and wireless enterprise-wide computer networks, intranets, extranets, and the Internet. Other embodiments include other types of communication networks, including telecommunications networks, cellular networks, paging networks, and other mobile networks. The server computer 146 may be configured to run server applications 147.

When used in a LAN networking environment, the computer 100 is connected to the LAN 148 through an adapter or network interface 152 (communicatively linked to the bus 106). When used in a WAN networking environment, the computer 100 often includes a modem 154 or other device, such as the network interface 152, for establishing communications over the WAN/Internet 150. The modem 154 may be communicatively linked between the interface 140 and the WAN/Internet 150. In a networked environment, program modules, application programs, or data, or portions thereof, can be stored in the server computer 146. In the depicted embodiment, the computer 100 is communicatively linked to the server computer 146 through the LAN 148 or the WAN/Internet 150 with TCP/IP middle layer network protocols; however, other similar network protocol layers are used in other embodiments. Those skilled in the relevant art will readily recognize that the network connections are only some examples of establishing communication links between computers, and other links may be used, including wireless links.

The server computer 146 is further communicatively linked to a legacy host data system 156 typically through the LAN 148 or the WAN/Internet 150 or other networking configuration such as a direct asynchronous connection (not shown). Other embodiments may support the server computer 146 and the legacy host data system 156 on one computer system by operating all server applications and legacy host data system on the one computer system. The legacy host data system 156 may take the form of a mainframe computer. The legacy host data system 156 is configured to run host applications 158, such as in system memory, and store host data 160 such as business related data.

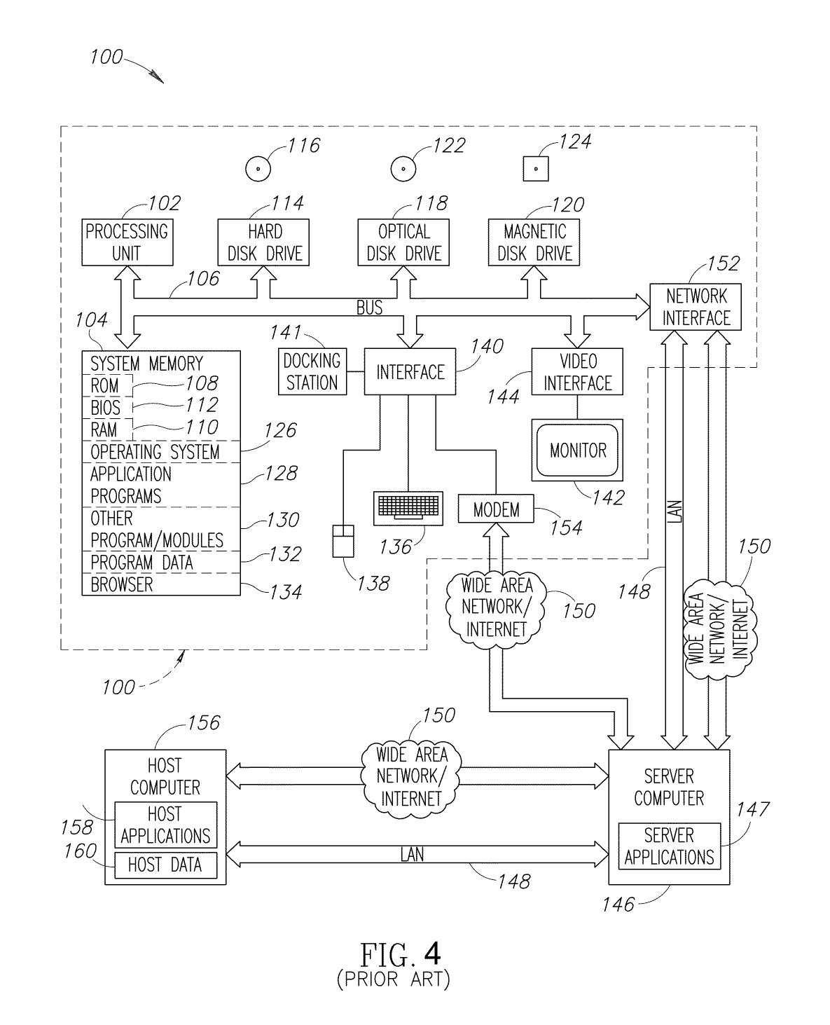

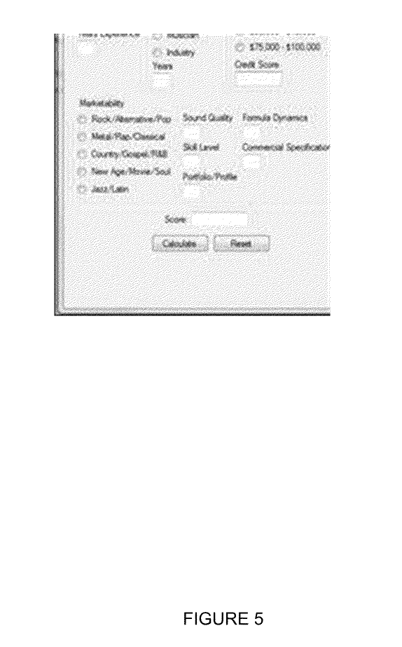

FIG. 5 is a screenshot of a calculator used for intellectual property mortgaging. The calculator of FIG. 5 is preferably configured to run on the computer of FIG. 4. The calculator is configured to analyze a piece of intellectual property and determine an overall score for a piece of intellectual property as described above. Either automatically or manually, information on a producer is entered. Music is analyzed, preferably using the computer of FIG. 4 to determine a genre, a sound quality, a skill level, formula dynamics, commercial specification and portfolio. These scores are analyzed, as described above, and based on the input music and the input producer information a score is output for use in mortgage decisions.

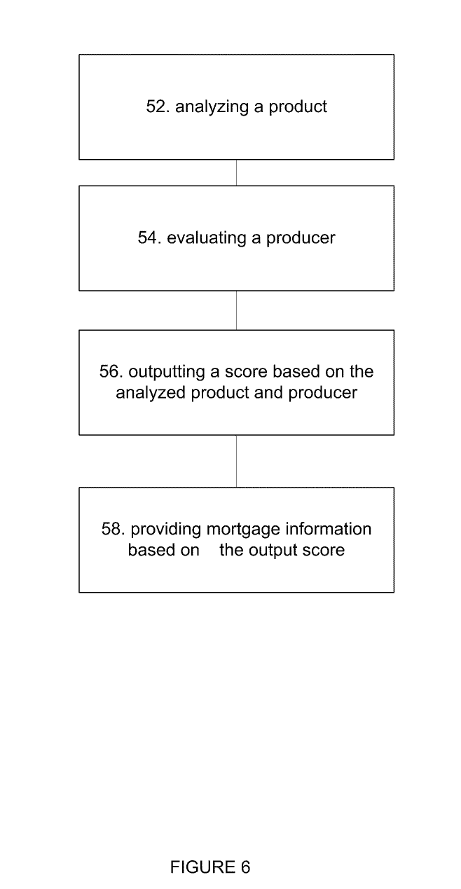

FIG. 6 is a method of evaluating intellectual property, preferably using the calculator of FIG. 5. At block 52, a product is analyzed. In an embodiment the product may include a photograph, music or some other creative product. The product is analyzed by the system for such factors as genre, sound quality, and skill level. Once the product has been evaluated, at block 54 a producer is evaluated. The producer or artist is analyzed based on factors including, but not limited to, experience, success and income. At block 56, a score is generated based on the analyzed product and producer. In order to determine a score, as described above, using the input product and input producer information. At block 58, mortgage information is provided. Determining mortgage information is described above.

The embodiments of the invention in which an exclusive property or privilege is claimed are defined as follows:

1. A method for consulting, managing, and production wherein a business entity provides intellectual property leveraging strategies, accounting, and finance methods for individual intellectual property producers, comprising:
performing an evaluation of an intellectual property product based on the intellectual property market strength of the intellectual property product produced by an intellectual property producer, the evaluation further comprising:
analyzing the intellectual property product using a processor on at least one computer;
evaluating a producer; and
outputting a score based on the analyzed product and producer;
determining the intellectual property producer's intellectual property needs to produce said intellectual property product, wherein those needs include at least one of the group of intellectual property development, production, marketing, or distribution;
establishing and documenting a mortgage, using the output score, for the intellectual property producer based on the producer's intellectual property needs and the evaluated intellectual property market strength of the intellectual property product, wherein business entity takes a financial interest in intellectual property produced; and
providing intellectual property needs to said intellectual property producer to produce said intellectual property product, wherein those needs include at least one of the group of intellectual property development, production, marketing, or distribution.

2. A system for consulting, managing, and production wherein a business entity provides intellectual property leveraging strategies, accounting, and finance methods for individual intellectual property producers, comprising:
a memory containing at least one intellectual property product;
a processor in data communication with the memory, further comprising:
a first component configured to analyze the at least one intellectual property product, such that a genre and a sound quality are stored in the memory;
a second component configured to analyze an artist of the at least one intellectual property product, such that a score is determined based on the experience and past success of the artist;
a third component configured to output a score for the artist and the intellectual property product such that the score represents an overall risk level of the input intellectual property product; and
a fourth component configured to prepare an agreement based on the output score of the intellectual property product.
